(19) United States
(12) Patent Application Publication
(10) Pub. No.: US 2010/0206600 A1
(43) Pub. Date: Aug. 19, 2010

(54) SEAL FOR AT LEAST ONE ELECTRICAL LINE

(76) Inventor: Werner HOFMEISTER, Muehlacker (DE)

Correspondence Address: KENYON & KENYON LLP, ONE BROADWAY, NEW YORK, NY, 10004, US

(21) Appl. No.: 12/641,482

(22) Filed: Dec. 18, 2009

(30) Foreign Application Priority Data
Dec. 23, 2008 (DE) 102008055124.4

(51) Int. Cl. H02G 15/20; H02G 3/00

(52) U.S. Cl. 174/8; 174/70 R

(57) ABSTRACT

An electrical line is to be insulated from fluid or corrosive media penetrating along the electrical line in an advantageous and cost-effective manner from the standpoint of production engineering. The electrical line having an electrically conductive inner conductor and an insulating jacket surrounding it includes a sealing element, which is disposed on the insulating jacket in a spring-back manner via a first subsection, and which covers the inner conductor across a partial length via a second subsection. The sealing element contains a soluble, in particular fluid sealant, which is pressed into the individual conductors of the inner conductor implemented as stranded wire, and cures in a sealing manner. The electrical line is used, for example, in the automotive industry for a cable harness plug.

### BACKGROUND INFORMATION

German Patent No. DE 10 2004 043 353 describes an electrical line having at least one electrically conductive inner conductor, which is surrounded by an insulating jacket. Disposed around the insulating jacket is a seal, which can be connected to the insulating jacket in a force-locking manner, thereby producing sealing between the insulating jacket and the seal.

In addition, in the case of an inner conductor made up of a stranded wire, it is known to prevent the entry of fluid into the stranded wire in that an additional sealant is absorbed by the stranded wire and then cured. This is disadvantageous because it requires an additional process which causes additional expense.

### SUMMARY OF THE INVENTION

The present invention is based on the objective of sealing an electrical line in an advantageous and cost-saving manner from the standpoint of production engineering.

The object is achieved by a seal for at least one electrical line according to the present invention.

The seal according to the present invention for at least one electrical line is provided with a sealing element which includes a soluble, in particular fluid sealant. This sealant is pressed into the inner conductor by a crimping process and by capillary action, and then cured. Because of the sealant already present in the sealing element, the electrical line is able to be sealed from fluid or corrosive media penetrating along the electrical line in an advantageous and cost-saving manner from the standpoint of production engineering.

Developing the sealing element as a single-wire seal introduces the sealant into the production process without an additional working step.

### BRIEF DESCRIPTION OF THE DRAWING

FIGS. 1 and 2 show a seal for an electrical line according to an exemplary embodiment of the present invention.

### DETAILED DESCRIPTION

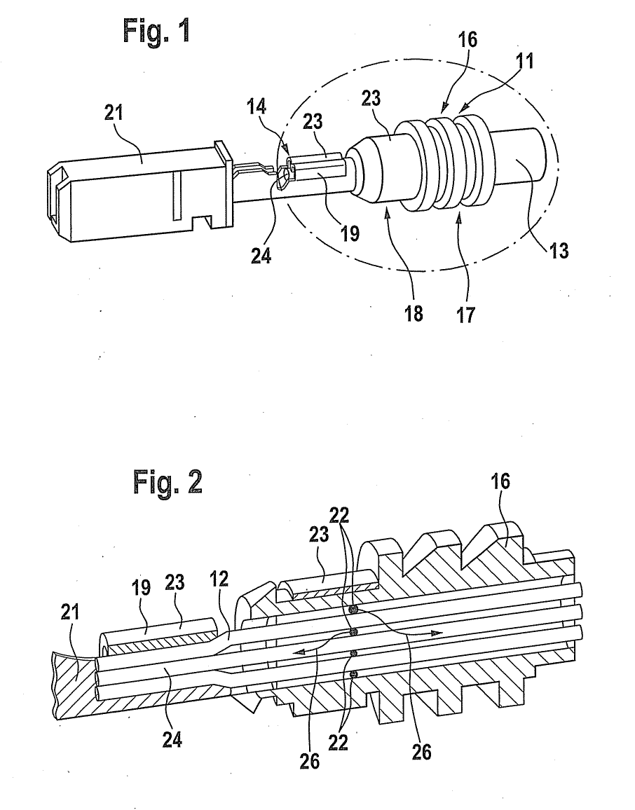

An electrical line 11, which is illustrated in FIGS. 1, 2, and may be part of a cable harness, has an electrically conductive inner conductor 12 surrounded by an insulating jacket 13. Insulating jacket 13 is removed in an end region 14 of electrical line 11.

A sealing element 16, implemented as a single-wire seal, is affixed on electrical line 11 in such a way that it is disposed on insulating jacket in a spring-back manner via a first subsection 17, and a second subsection 18 projects into end region 14 of electrical line 11 and covers inner conductor 12 across a partial length. The remaining partial length of inner conductor 12 projects into a contact point 19 of a contact part 21 to be contacted with electrical line 11.

Sealing element 11 is permeated by a soluble, in particular liquid sealant 22. In the crimping process at a crimping part 23, this sealant is pressed into inner conductor 12 developed as stranded wire 24 and seals the individual conductors of stranded wire 24 of inner conductor 12 from each other. The distribution of sealant 22 taking place in the crimping process is schematically indicated by arrows 26 in FIG. 2.

Because sealing element 16 already includes sealant 22, which, in the same working process, is sealingly introduced into inner conductor 12 when implementing the crimping connection at inner conductor 12, which is to be made anyway, electrical line 11 is able to be sealed in an advantageous and cost-effective manner from a standpoint of production engineering.

What is claimed is:

1. A seal for at least one electrical line having an electrically conductive inner conductor in the form of a stranded wire, which is surrounded by an insulating jacket, the seal comprising:
a sealing element containing a soluble sealant, which is pressed into the inner conductor in a crimping process and by capillary action, thereby entering into a sealing connection and insulating the inner conductor.

2. The seal according to claim 1, wherein the sealing element is implemented as a single-wire seal.

3. The seal according to claim 1, wherein the sealant is a fluid sealant.
